(19) United States
(12) Patent Application Publication
(10) Pub. No.: US 2002/0012365 A1
(43) Pub. Date: Jan. 31, 2002

(54) Method for the transmission of digital optical signals

(76) Inventor: Horst Mueller, Hohenschaeftlarn (DE)

Correspondence Address: Schiff Hardin & Waite, Patent Department, 233 South Wacker Drive, 6600 Floor Sears Tower, Chicago, IL, 60606, US

(21) Appl. No.: 09/900,681

(22) Filed: Jul. 6, 2001

(30) Foreign Application Priority Data
Jul. 6, 2000 (DE) 10032825.3

(51) Int. Cl. H04J 3/04

(52) U.S. Cl. 370/536

(57) ABSTRACT

A method for transmitting transport signals for different hierarchical levels, wherein lower level transport signals can be inserted into upper level transport signals, and all the transport signals have the same pulse frame including an optical channel overhead. The error rate is significantly reduced by means of forward error correction. Instead of transport signals of a lower hierarchy, tributary signals are inserted directly into the pulse frames of the transport signals of a higher hierarchy, and frequency matching is effected by stuffing.

### BACKGROUND OF THE INVENTION

1. Field of the Invention

The present invention relates to methods for transmitting digital optical signals and multiplex signals, particularly digital optical signals and multiplex signals having different data rates.

2. Discussion of the Related Art

In optical networks, the length of the path sections without regenerators can be increased by measures on the optical side such as increased transmission power and compensation of nonlinear effects. It is significantly more cost-effective, however, to permit an increased error rate and to reduce it again by means of error correction. ITU recommendation G975 describes one of the methods for error correction (forward error correction—FEC), which uses a block code and is provided for submarine cable links. The correction information is inserted into the pulse frame in each case at the end of a transmission block.

In the standardization committees, a method is being discussed in which, in addition to the error correction, an optical channel overhead, OH, is assigned to the useful signal in order to be able to monitor the signal in optical networks. This method is also known as “digital wrapper”. The overhead of the pulse frame also specifies which signals are transmitted in the pulse frame. Additional information for management and monitoring tasks is also transmitted in the overhead.

The technical problem, then, consists in specifying a method by which a plurality of mutually nonsynchronous signals provided with optical channel overhead and error correction and having different data formats and/or data rates can be combined to form transport signals. In short, in defining suitable data formats and transport rates for such an “optical transmission hierarchy”.

In addition, the intention is to enable other data formats of the synchronous hierarchies also to be inserted into a higher-order transport signal.

### SUMMARY OF THE INVENTION

An advantage of the present invention is that, in the individual (multiplexer) hierarchical levels, multiplex signals are formed which, provided with a common optical channel overhead and error correction, are transmitted as transport signal with a defined data rate. The transport signals can each be combined to form multiplex signals of a higher hierarchical level. Moreover, in the higher hierarchical levels, it is also directly possible for the tributary signals (of a lower hierarchy, e.g. SDH hierarchy) to be directly inserted after the formation of an optical unit group. Tributary signals in this case denotes the STM/SONET signals that are principally fed into the system or output, and likewise further data signals.

A further advantage of the present invention results from the definition of specific transmission rates. This results in independence from the accuracy of the signal source.

Yet a further advantage of the present invention is that frequency matching is effected by stuffing, and it is expedient to provide bit-by-bit stuffing in order to avoid relatively large jitter. Positive stuffing is proposed for reasons of simple realization. In principle, however, positive-0-negative stuffing, also byte-by-byte stuffing, is also possible.

### BRIEF DESCRIPTION OF THE DRAWINGS

FIG. 1 shows the combination of useful signals with and without optical channel overhead and correction information to form an optical transport signal;

FIG. 2 shows a multiplex device for three hierarchical levels and the linking thereof, according to the present invention;

FIG. 3 shows functional units of an optical channel multiplexer, according to the present invention;

FIG. 4 shows the pulse frame of a transport signal of the first hierarchical level;

FIG. 5 shows the permissible tolerance range of the transport signal;

FIG. 6 shows the pulse frame of the transport signal of the second hierarchical level with allocation with four STM-16 signals;

FIG. 7 shows the same pulse frame for allocation with an STM-64 signal;

FIG. 8 shows the permissible tolerance ranges of the transport signal of the second hierarchical level;

FIG. 9 shows the pulse frame for the transport signal of the third hierarchical level for allocation with four STM-64 signals;

FIG. 10 shows the pulse frame of the transport signal of the third hierarchical level for allocation with 16 transport signals of the first hierarchical level or 16 STM-16 signals;

FIG. 11 shows the pulse frame of the transport signal for allocation with an STM-256 signal; and

FIG. 12 shows the permissible tolerance of the transport signal of the third level for different allocations.

### DETAILED DESCRIPTION OF THE PRESENTLY PREFERRED EMBODIMENTS

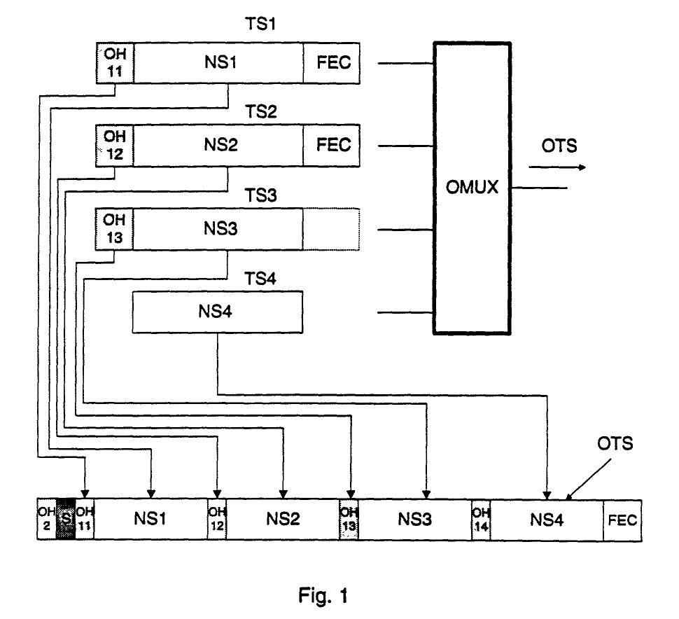

FIG. 1 shows a basic possibility for forming a multiplex signal from four tributary signals TS1-TS4, of which two each contain an overhead OH11, OH12, useful signals NS1 and NS2 and FEC correction information FEC, one contains an overhead OH13 and a useful signal NS3 and a fourth comprises only a useful signal NS4. The fourth useful signal NS4 is, for example, a transport module STM-N of the synchronous digital hierarchy (whose overhead is regarded as part of the useful signal). Before the time division multiplexing of these four tributary/basic signals TS1-TS4 in the optical multiplexer OMUX, firstly the error correction—if present—is carried out. In the case of the first two signals TS1 and TS2, only the associated optical channel overhead OH11 and the useful signal NS1 and, respectively, the overhead OH12 and the useful signal NS2 are accepted into the pulse frame of the multiplex signal, the optical transport signal OTS (also designated as optical transport unit OTU). The tributary signal TS3 is accepted in its entirety, and, in the case of the tributary signal TS4, an overhead OH14 is generated and then the useful signal NS4 is accepted.

Since the data type of the optical transport signal is defined and the tributary signals are synchronous neither with respect to one another nor with respect to the transport signal, frequency matching must be effected with the aid of stuffing information SI. In addition, an overhead OH2 is formed for the optical transport signal OTS, which overhead is placed before the rest of the data and contains control and monitoring information. The composition of the transport signal OTS, i.e. the type of the different transport or tributary signals inserted, can also be gathered from the overhead OH2. This information can also be communicated to the reception terminal by a management system.

In order to realize the structure illustrated, in which the tributary signals are strung together, relatively large buffer memories are required, so that it is not very suitable for realization.

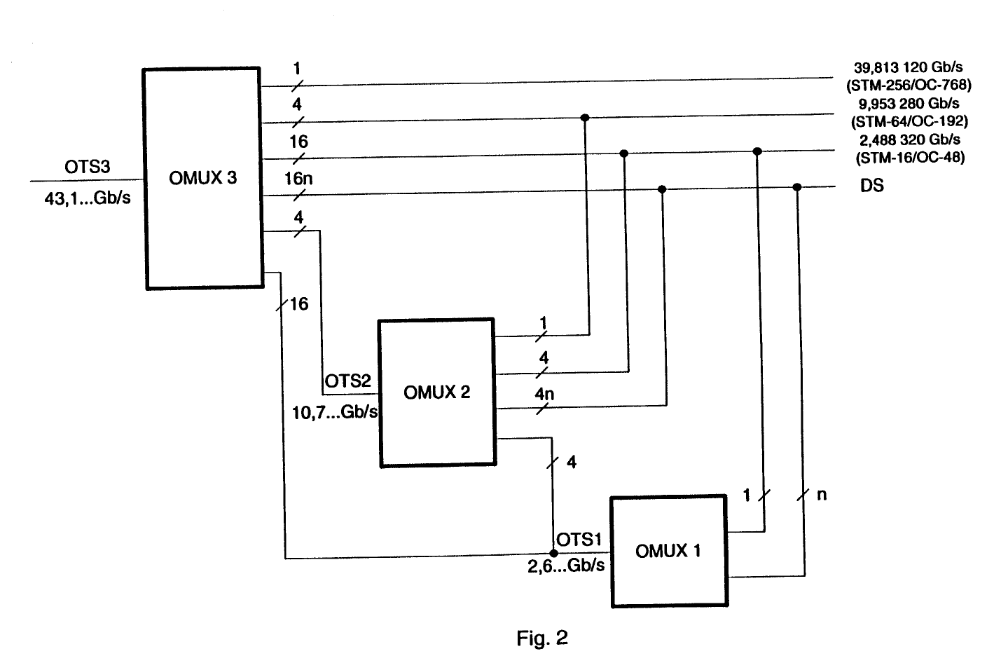

FIG. 2 illustrates the inventive multiplexer scheme. The first optical multiplexer OMUX1 may be present up to 16 times and the second optical multiplexer OMUX2 may be present up to 4 times, in order to generate an optical transport signal OTS3.

By way of example, an STM-16 signal of the synchronous digital hierarchy or a corresponding signal OC-48 of the SONET hierarchy is fed as tributary signal (basic signal) to the optical multiplexer OMUX1 of the first hierarchical level. Instead of a tributary signal STM-16, the optical multiplexer OMUX1 can also combine n (n=2, 3, 4, . . . ) data signals DS having a lower data rate firstly to form a multiplex data signal MDS and then to form the transport signal OTS1.

The optical multiplexer OMUX2 of the second hierarchical level can generate a transport signal OTS2 from a tributary signal STM-64/OC-192 or four tributary signals STM-16/OC-48 and/or four transport signals OTS1 or 4n (n=2, 3, 4, . . . ) data signals DS. A mixture of optical transport signals OTS1, tributary signals STM-16/OC-48 and multiplex data signals MDS is likewise possible.

Up to four of these multiplexers OMUX2 may in turn be present in order to generate four transport signals OTS2 of the second hierarchical level, which are combined to form the transport signal OTS3 if no tributary signals are directly inserted in the third hierarchical level.

The optical multiplexer OMUX3 of the third hierarchical level can generate a transport signal OTS3 from a tributary signal STM-256/OC-768 or four tributary signals STM-64/OC-192 and/or four optical transport signals OTS2 or 16 tributary signals STM-16/OC-48 and/or 16 transport signals OTS1 and/or 16n (n=2, 3, 4, . . . ) data signals DS.

The transport signal OTS3 may equally contain a mixture of the transport signals OTS1 and OTS2 and of tributary signals and data signals. The transport signal OTS3 may in turn also contain a mixture of transport signals of the lower hierarchical levels, of tributary signals and of data signals.

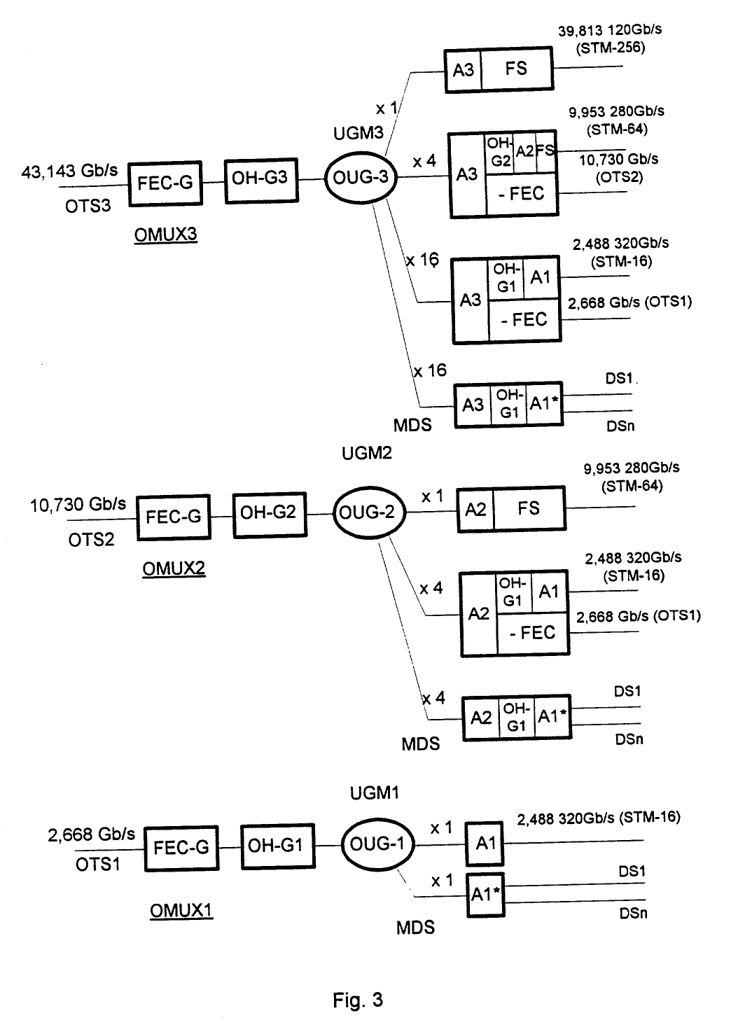

FIG. 3 illustrates the functional blocks of the optical transmission hierarchy (optical transport hierarchy) for the “optical channel multiplexers” shown in FIG. 2. The multiplexer OMUXI contains a timing alignment Al, to which is fed an STM16 signal synchronized with the optical transport signal OTS1. Instead of this STM-16 signal, it is possible to transmit a plurality of data signals DS1 to DSn which, combined to form a first optical unit group OUG-1 in a first unit group multiplexer UGM1, are inserted into the pulse frame. The optical channel overhead OH1 is generated in an optical channel generator OH1-G1. This optical channel overhead may also contain information about the content of the optical unit group. The error correction information FEC is added by an FEC coding device FEC-G. The optical transport signal OTS1 is thus completely generated. After electro-optical conversion (not illustrated), this can be transmitted via corresponding transmission systems. If, instead of the STM16 signal, n data signals DS (“client signals”) are combined firstly to form a multiplex data signal and then to form an optical unit group OUG-1, a variant A1* of the frequency matching is required for each data signal DS1 to DSn.

As already explained for FIG. 2, the multiplexer OMUX2 generates the optical transport signal OTS2, which has a data rate of 10.730 Gb/s. This transport signal may contain four transport signals OTS1 which, in accordance with the tributary signals TS1 and TS2 according to FIG. 1—without FEC correction information—after passing through the frequency matching A2, are combined to form a second optical unit group OUG-2. Equally, it is possible to combine four signals STM-16 after the frequency matching A1 and A2 to form said optical unit group, to which an optical channel overhead OH2 is added.

Equally, it is possible to combine four multiplex data signals MDS after frequency matching A1*, A2 to form an optical unit group. Equally, an STM-64 signal may also form an optical unit group OUG-2 after frequency matching A2. Said optical unit group is provided with an optical channel overhead OH2 by an optical channel overhead generator OH-G2 and correction information FEC is subsequently added in an FEC coding device FEC-G. The complete second optical transport signal OTS2 can be transmitted via a 10 Gb/s link.

The third multiplexer OMUX3 can in turn transmit, in a corresponding manner, an STM-256 signal, up to 4 STM-64 signals or 4 OTS2 signals or up to 16 STM-16 signals and/or OTS1 signals or up to 16n data signals DS and/or a mixture of the signals. The timing alignment A3 is effected in a corresponding manner. Instead of the SDH signals, the corresponding SONET signals can be transmitted in each case.

FIGS. 2 and 3 should be considered to be diagrammatic. If a signal passes through a plurality of instances of frequency matching A, one of the instances of frequency matching may also comprise only “fixed stuffing information” (fixed stuff). Equally, the multiplex scheme for separating individual signals is carried out in the reverse order, with individual steps being able to be omitted.

The mapping (insertion) of the tributary signals and transport signals and also the frequency matching thereof will now be explained in more detail.

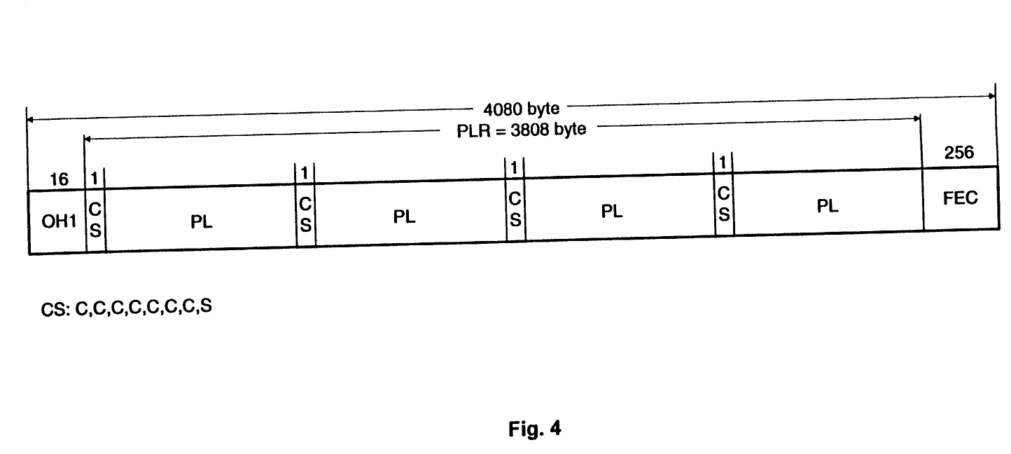

FIG. 4 illustrates how an STM-16 signal (OC-48 signal of the SONET hierarchy) is supplemented to form a transport signal OTS1. In order to match the bit rate of the tributary signal STM-16 to the bit rate of the transport signal OTS1, a positive stuffing method is proposed, which is distinguished by particular simplicity and is entirely adequate for frequency matching. In principle, any stuffing method can be employed. The stuffing information is distributed in the form of stuffing bytes CS at least approximately uniformly in the pulse frame. In accordance with FIG. 4, for reasons of simpler processability, the payload PLR=3808 bytes of the pulse frame comprising 4080 bytes in total is divided into four equal parts, each of which is preceded by a stuffing byte CS containing seven bits of stuffing control information C and one stuffing bit S. The stuffing control information C specifies whether the stuffing bit S comprises information or no information. For the stuffing information, two binary combinations having the largest possible Hamming distance are chosen, in order to have the greatest possible protection against interference. If e.g. 0000000 are allocated to the stuffing information bits C, this means that the stuffing bit is a stuffing bit, whereas in the event of allocation with seven logic l's, the stuffing bit is an information bit. A majority decision is taken in the event of disturbed stuffing information bits.

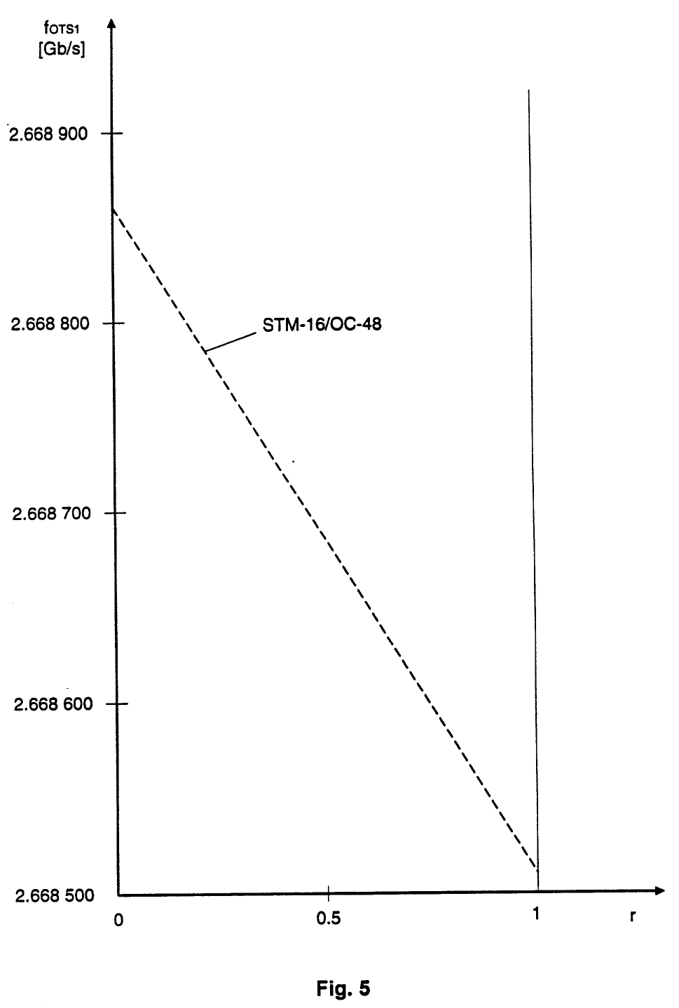

FIG. 5 shows the dependence of the data rate f_{PTS1} of the transport signal OTS1 on the stuffing rate r if an STM-16/OC-48 signal is inserted. The permissible frequency range of the optical transport signal or of the signal to be inserted can be determined from this. If it is assumed that the frequency of the STM-16 signal is exactly correct and no information bits are transmitted as stuffing bits, the highest permissible data rate results for the optical transport signal OTSI. At the lowest permissible data rate, an information bit is continually transmitted in the stuffing byte, which corresponds to a stuffing rate 1.

A useful signal NS=951 bytes×4×8+4r=30,432+4r) bits are transmitted in a pulse frame. The data rate of the STM16 signal is 2.488320 Gbit/s. Since the transmission data rates are in the same ratio as the number of transmitted bits, a transmission rate of:

f_{OTS1}=2.488320 Gbit/s×4080×8 bits/(30,432+4r) bits (1)

thus results for the transport signal.

The corresponding straight line is disclosed in FIG. 5. At an average data rate of 2.66866855 Gbit/s, the maximum frequency deviation of the STM16 signal can thus be:

Δf_{OTS1}=±2 bits/(30,432+2) bits=±65.7 ppm. (2)

This is much higher than the permissible tolerance of 4.6 ppm for SDH signals or the permissible tolerance of 20 ppm for SONET signals.

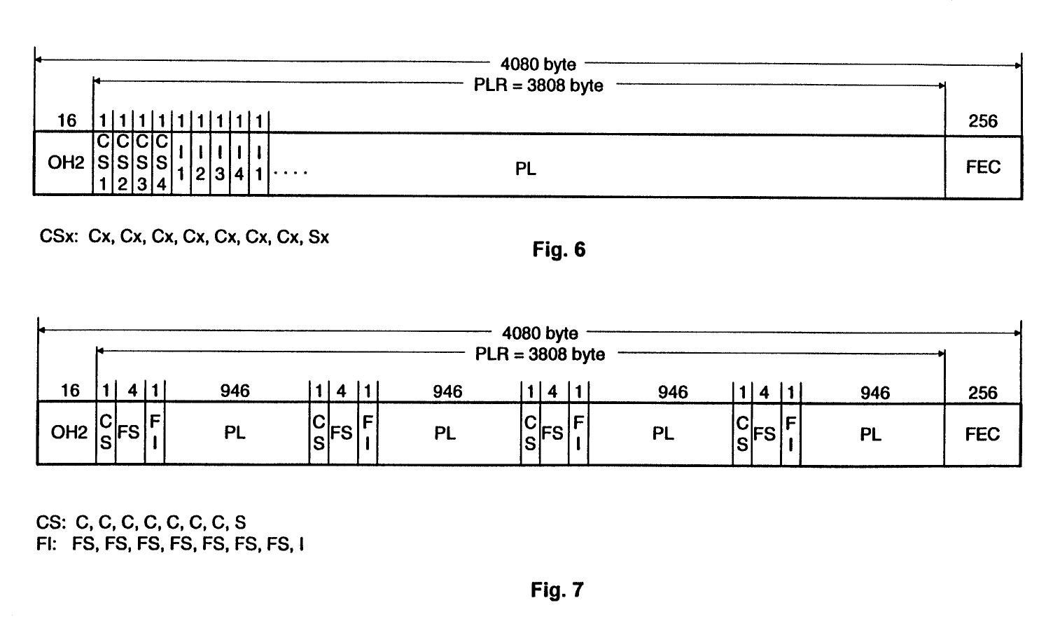

FIG. 6 illustrates the frame structure of a transport signal OTS2 for allocation with 4 STM-16/OC-48 signals. The total length of the frame and the payload correspond to the pulse frame of the first transport signal. Since four tributary signals STM-16 are inserted by byte-by-byte interleaving, the stuffing bytes can be arranged at any desired point. Each stuffing byte CS1, CS2, . . . in each case contains seven stuffing information bits C and one stuffing bit S.

This results in the dependence, illustrated in FIG. 8, of the transmission bit rate f_{OTS2} on the stuffing rate r:

f_{OTS2}=f_{OTS1}×3824×4080×8/4080×(3804×8/4+r) (4)

At a transmission bit rate f=2.668685 Gbit/s, the result is a tolerance range of:

Δf_{OTS2}=±0.5 bit/(3804×8/4+0.5) bit=±65.7 ppm. (5)

The function illustrated by a dashed line in FIG. 8 applies to the signals STM-16/OC-48 and OTS1.

In accordance with the function diagram illustrated in FIG. 3, it is possible firstly to perform matching of the STM-16 signals to the desired bit rate of the first transport signal or of the second transport signal OTS2 in the frequency matching Al before the multiplexing of the signals, in order then also to carry out frequency matching A2 to the second transport signal OTS2. However, single frequency matching to the transport signal also suffices.

FIG. 7 illustrates insertion of an STM-64/OC-192 signal into the pulse frame of the transport signal OTS2. The periphery of the pulse frame has remained the same again. In order to achieve prematching of the data rates in the most exact manner possible, four groups each having 4×8+7=39 bits of fixed stuffing information (fixed stuff) FS and Fl are inserted, which are distributed approximately equally. Also provided are four stuffing bytes CS which are likewise equally distributed and again contain seven stuffing information bits and one stuffing bit. This results in a transmission bit rate f_{OTS2} as a function of the stuffing rate r

f_{OTS2}=9.953280 Gbit/s×4080×8 bits/(30,276+4r) bits (6)

the corresponding straight line is shown by a solid line in FIG. 8. The frequency deviation of the transport signal from the tributary signal is thus permitted (9) to be:

Δf_{OTS2}=±2 bits/(30,276+2) bits=±66 ppm. (7)

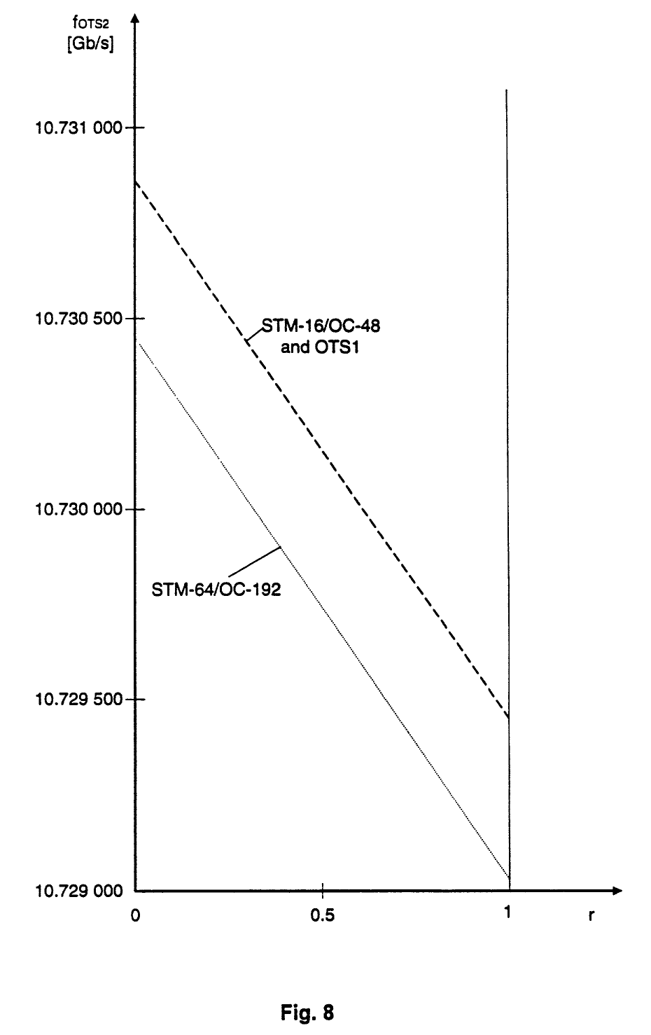

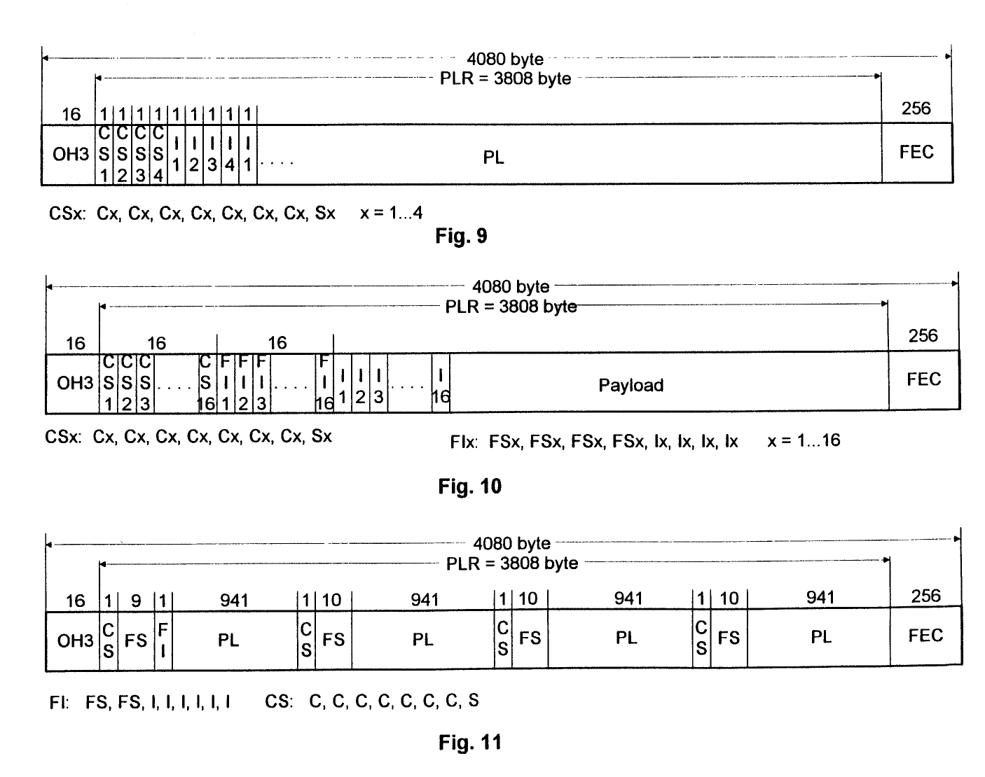

FIG. 9 illustrates the pulse frame after the insertion of four transport signals OTS2 or four STM-64/OC-192 signals into the pulse frame of a transport signal OTS3. The signals are interleaved byte by byte. A stuffing byte CS having seven stuffing information bits Cx and one stuffing bit Sx is provided for each tributary/basic signal.

The data rate of the third transport signal is:

f_{OTS3}=f_{OTS2}×3824×4080×8/4080(38,004×8/4+r) (8)

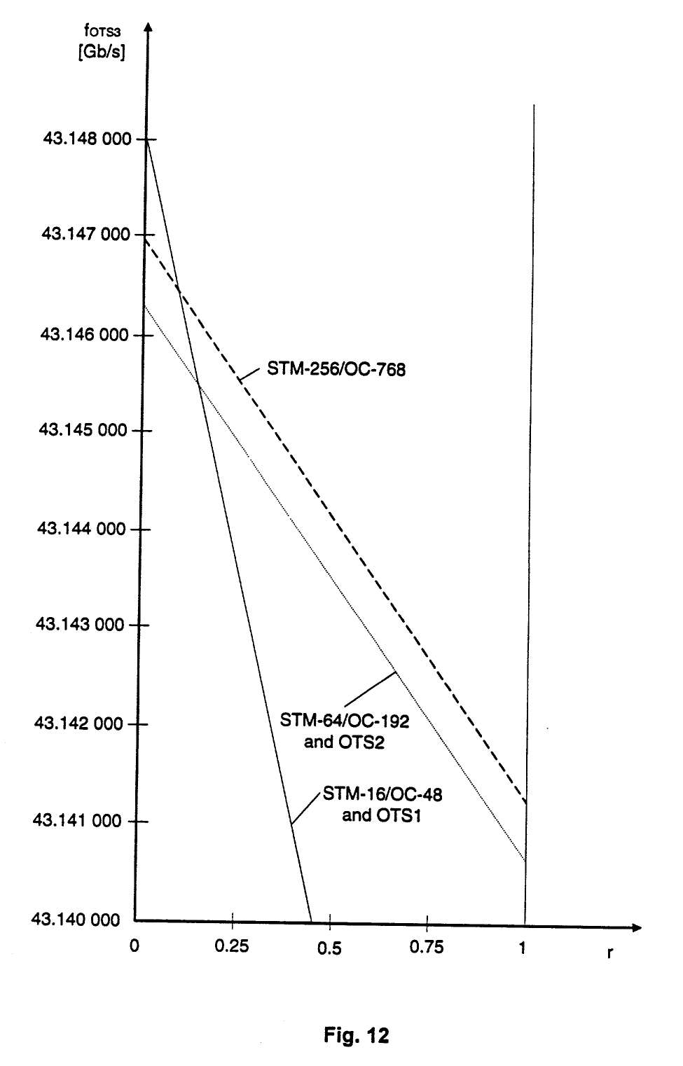

In this case, a bit rate f_{OTS2}=10.730158 Gbit/s was assumed for the transport signal OTS2. The corresponding straight line is shown by a solid line in FIG. 12. The permissible frequency deviation of the transport signal from the tributary signal is:

Δf_{OTS2}=±0.5 bit/3804×8/4+0.5) bits=±65.7 ppm. (9)

FIG. 10 illustrates the pulse frame for 16 inserted transport signals OTS1 or 16 STM-16/OC-48 signals. These signals are again interleaved byte by byte.

The first timing alignment is then effected by insertion of fixed stuffing information FI. The bytes FI1, FI2, FI3, . . . each contain four fixed stuffing bits FSx and four information bits Ix. The matching by stuffing is effected with the aid of the stuffing bytes CS1, CS2, CS3, . . . , which again contain seven stuffing information bits Cx and one stuffing bit Sx. The data rate of the third transport signal is:

f_{OTS3}=f_{OTS1}×3824×4080×8/4080(3792×8/16−4+r) (10)

This corresponds to the solid line in FIG. 12.

If f_{OS1}=2.668685 Gbit/s is assumed for the data rate for the first transport signal, the permissible deviation is:

Δf_{OTS3}=±0.5 bit/(3792×8/16−4+0.5) bits=±264 ppm. (11)

The fixed stuffing information and the stuffing bytes may be distributed as desired.

FIG. 11 shows the insertion of an STM-256/OC-768 signal into the pulse frame of the transport signal OTS3. An approximate matching of the transmission bit rates is once again effected by means of fixed stuffing information. The bytes FS in this case contain 8 stuffing bits F and the bytes Fl each contain two fixed stuffing bits and six information bits. 4 stuffing bytes CS are provided in order to enable the exact frequency matching. With four stuffing bytes CS which each again contain seven stuffing information bits and one stuffing bit, the result is the dashed characteristic in FIG. 12 for the permissible frequency deviations. The stuffing bytes CS and the stuffing information FS and FI can largely be arranged freely.

As a function of the stuffing rate, a data rate:

f_{OTS3}=39.813120 Gbit/s×4080×8 bits/(30,118+4r) bits (12)

results for the transport signal OTS3. This straight line is shown by a dashed line in FIG. 12.

The permissible frequency deviation of the transport signal from the tributary signal is:

Δf_{OTS3}=±2 bits/(30,118+2) bits=±66 ppm. (13)

A plurality of these pulse frames with 4080 bytes can be combined in a manner known per se to form a super-pulse frame. The latter makes it possible to transmit more overhead information.

Although modifications and changes may be suggested by those skilled in the art to which this invention pertains, it is the intention of the inventor to embody within the patent warranted hereon all changes and modifications that may reasonably and properly come under the scope of his contribution to the art.

What is claimed is:

1. A method for transmitting digital optical signals having different data rates, by means of transport signals including a uniform pulse frame with a payload, an optical channel overhead and forward error correction information, the method comprising the steps of:
forming a first optical transport signal of a first hierarchical level by inserting a tributary signal into a payload of a pulse frame such that frequency matching is effected and an optical channel overhead and forward error correction information are added;
forming a second optical transport signal of a second hierarchical level, by forming an optical unit group from four optical transport signals without the forward error correction information thereof and/or from complete tributary signals of the first hierarchical level or a tributary signal of the second hierarchical level, such that frequency matching is effected between the transport signals of the first hierarchical level and/or the tributary signals and the second transport signal, wherein an optical channel overhead is added and forward error correction coding is carried out; and
forming a third transport signal of a third hierarchical level, by forming a third optical unit group from transport signals without the overhead thereof and/or tributary signals of the first hierarchical level or from transport signals without the overhead thereof and/or tributary signals of the second hierarchical level, or by forming a tributary signal of the third hierarchical level, such that frequency matching is effected between the transport signals and/or the tributary signals and the third transport signal, wherein an optical channel overhead is formed and the forward error correction coding is carried out.

2. The method as claimed in claim 1, further comprising the step of:
forming in the first hierarchical level a first optical unit group comprising a tributary signal of the first hierarchical level.

3. The method as claimed in claim 2, further comprising the step of:
forming the first optical unit group comprising a tributary signal or data signals in the first hierarchical level.

4. The method as claimed in claim 3, wherein the payload of the pulse frame comprises 3808 bytes, the overhead comprises sixteen bytes and the forward error correction information comprises 256 bytes.

5. The method as claimed in claim 4, further comprising the step of:
inserting four stuffing bytes in a manner distributed at least approximately uniformly over the payload of the pulse frame which contains in each case seven stuffing information bits and one stuffing bit for the transmission of a tributary signal in a transport signal of the first hierarchical level.

6. The method as claimed in claim 4, further comprising the step of:
carrying out a positive stuffing method for the purpose of matching the data rates between tributary signals and the transport signal.

7. The method as claimed in claim 4, further comprising the steps of:
interleaving transport and/or tributary signals byte-by-byte for the transmission of a total of four transport signals or tributary signals of the first hierarchal level;
inserting a stuffing byte comprising seven stuffing information bits and one stuffing bit into each transport or tributary signal; and
effecting a match to the data rate of the transport signal by means of a positive stuffing method.

8. The method as claimed in claim 4, further comprising the steps of:
interleaving transport and/or tributary signals byte-by-byte for the transmission of a tributary signal in a transport signal of the second hierarchical level; and
effecting first matching of the data rates by adding four groups of fixed stuffing information having 39 bits in each case, such that at least four approximately equally distributed stuffing bytes are additionally inserted which each contain seven stuffing information bits and one stuffing bit, wherein a positive stuffing method is carried out for matching to the data rate of the transport signal.

9. The method as claimed in claim 4, further comprising the steps of:
interleaving transport and/or tributary signals byte-by-byte for the transmission of a total of four transport signals or four tributary signals of a second hierarchical level; and
inserting four stuffing bytes into the pulse frame, each stuffing byte containing seven stuffing information bits and one stuffing bit, wherein a positive stuffing method is carried out for matching to the data rate of the transport signal.

10. The method as claimed in claim 4, further comprising the step of:
inserting the transport and/or tributary signals into the pulse frame in a manner such that they are interleaved with one another byte-by-byte, for the transmission of a total of sixteen transport signals or sixteen tributary signals of a first hierarchal level, in a transport signal of the third hierarchical level, such that for each transport or tributary signal, first fixed matching of the data rate is effected by means of a respective stuffing byte having four fixed stuffing bits and four information bits, wherein four each transport or tributary signal, a stuffing byte is inserted into the pulse frame, said byte containing seven stuffing information bits and one stuffing bit, in that a positive stuffing method is carried out.

11. The method as claimed in claim 4, further comprising the step of:
effecting first matching of the data rates by means of fixed stuffing information of 314 bits, for the transmission of a tributary signal of the third hierarchal level in a transport signal of the third hierarchal level, in that four stuffing bytes each containing seven stuffing information bits and one stuffing bit are inserted, wherein a positive stuffing method is carried out for matching to the data rate of the transport signal.

12. The method as claimed in claim 11, further comprising the step of:
effecting the frequency matching during the insertion of transport signals or tributary signals into transport signals of a higher hierarchical level in a plurality of stages.

13. The method as claimed in claim 12, further comprising the step of: effecting frequency matching by inserting fixed stuffing information.
